(19) United States
(12) Patent Application Publication
(10) Pub. No.: US 2014/0078160 A1
(43) Pub. Date: Mar. 20, 2014

(54) DISPLAY-CONTROLLING METHOD AND DISPLAY DEVICE

(71) Applicant: DELTA ELECTRONICS, INC., Taoyuan Hsien (TW)

(72) Inventors: Chung-Yi YANG, Taoyuan Hsien (TW); Bao-Kim LIU, Taoyuan Hsien (TW); Ying-Kuang CHENG, Taoyuan Hsien (TW)

(73) Assignee: DELTA ELECTRONICS, INC., Taoyuan Hsien (TW)

(21) Appl. No.: 13/771,767

(22) Filed: Feb. 20, 2013

(30) Foreign Application Priority Data
Sep. 17, 2012 (TW) 101133912

(51) Int. Cl. G09G 5/00

(52) U.S. Cl. CPC G09G 5/001
USPC 345/531

(57) ABSTRACT

A display-controlling method for controlling a display device to dynamically adjust a display configuration tag is disclosed in this invention. The display-controlling method includes steps of: determining whether a predetermined display function is enabled on the display device; selectively writing the display configuration tag complying with different display signal transmission protocols into a storage unit of the display device according to whether the predetermined display function is enabled on the display device; and, reading the display configuration tag and selectively providing a display signal complying with one of the different display signal transmission protocols. In addition, a display device is also disclosed herein.

### RELATED APPLICATIONS

This application claims priority to Taiwan Application Serial Number 101133912, filed Sep. 17, 2012, which is herein incorporated by reference.

### BACKGROUND

1. Field of Invention

This invention relates to a display-controlling method. More particularly, this invention relates to a display-controlling method for dynamically controlling a configuration of a display device.

2. Description of Related Art

In recent years, the display is increasingly improved and gradually diversified, and for the convenience of users to set the display device, when a display signal source is connected with the display device, the display signal source may read back from the display device a particular display configuration tag through a display transmission interface, for example, extended display identification data (EDID). The setting, displaying capability and limitation and the like of the display device are obtained from the content of the EDID.

In traditional EDID configuration methods, the EDID is written in advance into a non-volatile memory unit, for example, an electrically-erasable programmable read-only memory (EEPROM), by an external EDID writer or microcontroller unit (MCU) before the display device leaves the factory. In conventional methods, the EDID saved by the display device cannot be changed freely after the display device leaves the factory.

The capability and information of the present display device are described in details in the EDID, and it is beneficial for the display signal source to know a supported signal specification necessary for the presently-driven display device, so as to transmit an appropriate signal format to the display device for displaying. Moreover, a particular display-driving function may be further enabled or closed by the display signal source according to the EDID content on the display device.

When the display configuration tag (such as the EDID) on the display device belongs to a particular format or protocol, some particular display-driving functions will be enabled or closed by the display signal source after reading the display configuration tag on the display device, for example, a horizontal/vertical spanning function required in supporting the display device to implement an edge blending function. However, the display configuration tag of a conventional display device is configured in advance before the display device leaves the factory and cannot be changed dynamically, such that the display device and parts of the display-driving functions of the display signal source are closed forcibly in some applications. That is, the display configuration tag on the display device that cannot be changed will limit flexibility of the application of the display device.

### SUMMARY

For solving the above-mentioned problems, this invention provides a display-controlling method for controlling a display device to dynamically adjust a display configuration tag of the display device itself. For example, the content of the display configuration tag may be dynamically changed according to whether some predetermined display functions (for example, an edge blending function or other display-operating functions specified by a user through an on-screen display interface or a communication connection interface) are enabled, such that the display configuration tag is complying with different display signal transmission protocols, so as to make the predetermined display functions performed correctly and smoothly. Alternatively, the display device may be operable to dynamically change the content of the display configuration tag on the display device according to a signal characteristic of a display signal transmitted from a display signal source, such that a more preferred compatibility exists between the display device and the display signal source.

An aspect of this invention provides a display-controlling method for controlling a display device to dynamically adjust a display configuration tag, wherein a display signal source connected with the display device selectively provides a display signal complying with a first display signal transmission protocol or a second display signal transmission protocol according to the display configuration tag. The display-controlling method includes: determining whether a predetermined display function is enabled on the display device; and selectively writing the display configuration tag complying with the first display signal transmission protocol or the display configuration tag complying with the second display signal transmission protocol into a storage unit of the display device according to whether the predetermined display function is enabled on the display device.

Another aspect of this invention provides a display-controlling method for controlling a display device to dynamically adjust a display configuration tag, wherein the display device is connected to a display signal source. The display-controlling method includes: transmitting a display signal to the display device from the display signal source; determining whether the display signal is complying with a first display signal transmission protocol by the display device; and, selectively writing the display configuration tag complying with the first display signal transmission protocol or the display configuration tag complying with a second display signal transmission protocol into a storage unit of the display device according to whether the display signal is complying with the first display signal transmission protocol.

Another aspect of this invention provides a display device, which includes a display-connecting interface, a display signal receptor, a storage unit and a processing unit. The display-connecting interface is connected to a display signal source. The display signal receptor is coupled with the display-connecting interface for receiving a display signal from the display signal source. The storage unit is coupled with the display-connecting interface for storing a display configuration tag. The processing unit is coupled with the storage unit for selectively writing the display configuration tag complying with the first display signal transmission protocol or the second display signal transmission protocol into the storage unit.

### BRIEF DESCRIPTION OF THE DRAWINGS

In order to make the foregoing as well as other aspects, features, advantages and embodiments of this invention more apparent, the accompanying drawings are described as follows:

FIG. 1 illustrates a schematic diagram of multiple display devices which are combined with an edge blending technique for displaying;

FIG. 2A illustrates a schematic flow diagram of a display-controlling method according to a first embodiment of this invention;

FIG. 2B illustrates a schematic flow diagram of a display-controlling method according to a second embodiment of this invention;

FIG. 3 illustrates a schematic flow diagram of a display-controlling method according to a third embodiment of this invention; and

FIG. 4 illustrates a schematic diagram of a display device according to an embodiment of this invention; and

FIG. 5 illustrates a schematic diagram of a display device according to another embodiment of this invention.

### DETAILED DESCRIPTION

A display-controlling method for controlling the display device to dynamically adjust the display configuration tag of the display device itself is disclosed in this invention. In an embodiment, the display device may be a projector, and it also may be other displays. In this embodiment, the display configuration tag on the display device may be the extended display identification data (EDID).

The EDID is a standard established by the Video Electronics Standards Association (VESA) based on a plug and play requirement of the users. The EDID is required and stored in both of the display device equipped with a digital visual interface (DVI) and the display device equipped with a high-definition multimedia interface (HDMI).

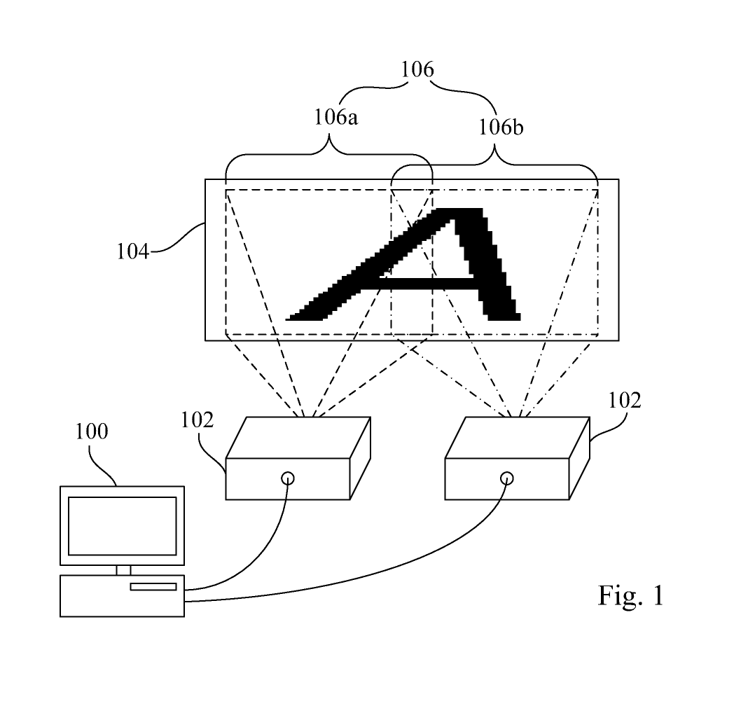

In present display applications, the requirement for a large display frame is gradually enhanced, and a signal source end also has the capability of outputting multiple split display frames to be spanned among display devices simultaneously. As a result, a technique combing multiple display devices into a single large screen is developed by manufacturers. Referring to FIG. 1, it illustrates a schematic diagram of multiple display devices which are combined with the edge blending function for display. As shown in FIG. 1, the edge blending function is that multiple projectors 102 are driven by a display signal source 100 to form a projecting frame 106 with a larger dimension on a projecting screen 104. The edges of sub frames (106a and 106b) projected by multiple projectors 102 are jointed with each other for forming the projecting frame 106 with an even larger dimension. As shown in FIG. 1, the projectors having the edge blending function are cooperated with the display signal source having the horizontal/vertical spanning function.

However, when multiple projectors with the edge blending function are utilized to project a larger frame, the display signal source 100 (such as a display card) must have the capability by which the same frame may be split and displayed simultaneously on different displays and the frame may be tailored and spanned horizontally or vertically and simultaneously supplied to a left and right or top and bottom projectors for displaying. At this time, the horizontal/vertical spanning function must be enabled by the display signal source 100.

In traditional personal computers, the frame using the horizontal/vertical spanning function may be generally generated by using an independent display card with a powerful function, while the independent display card on the personal computer generally performs the output based on the DVI on the personal computer.

For the display device (such as the projector) in the consumer entertainment (CE) industry, the HDMI is mostly used for receiving a digital video signal. However, in conventional technologies, when the EDID corresponding to the HDMI on the projector is read by the display signal source (such as the independent display card), the projector is determined as an HDMI display device by the display signal source which corresponds to the CE use requirements. Since the display signal source closes the horizontal/vertical spanning function according to the EDID stored by the HDMI display device (that is, without supporting the horizontal/vertical spanning), the large frame cannot be displayed simultaneously on multiple display devices (the projectors) with the horizontal/vertical spanning manner. Therefore, this invention provides a method for dynamically adjusting the display configuration tag to enhance the use flexibility of the display device.

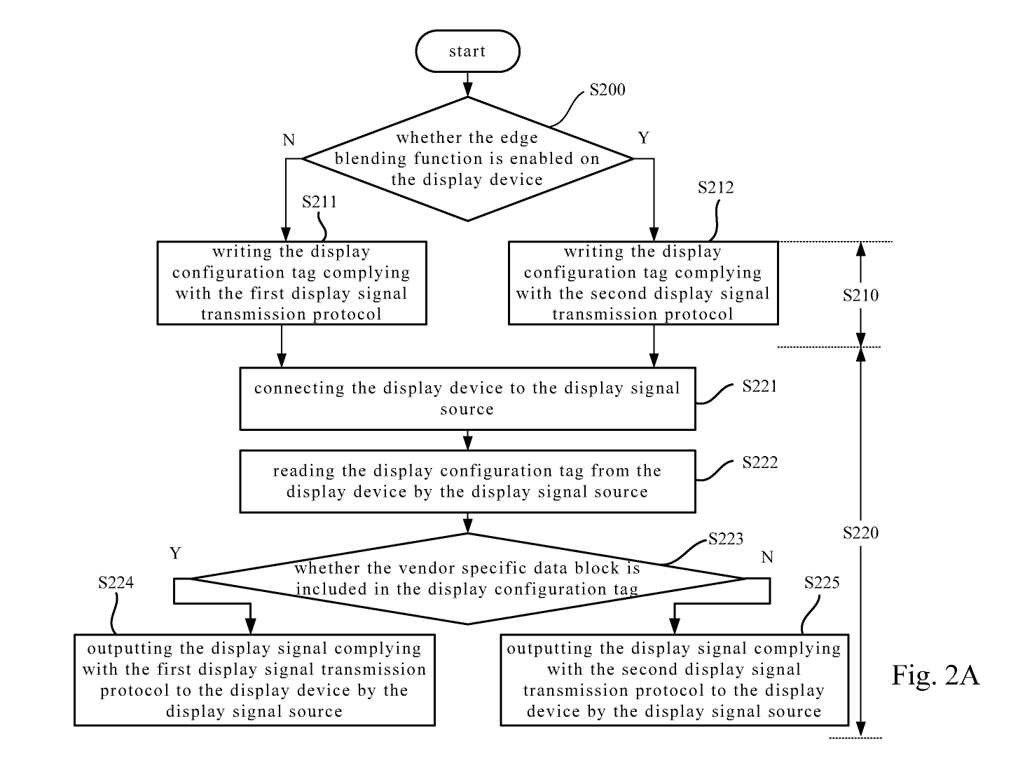

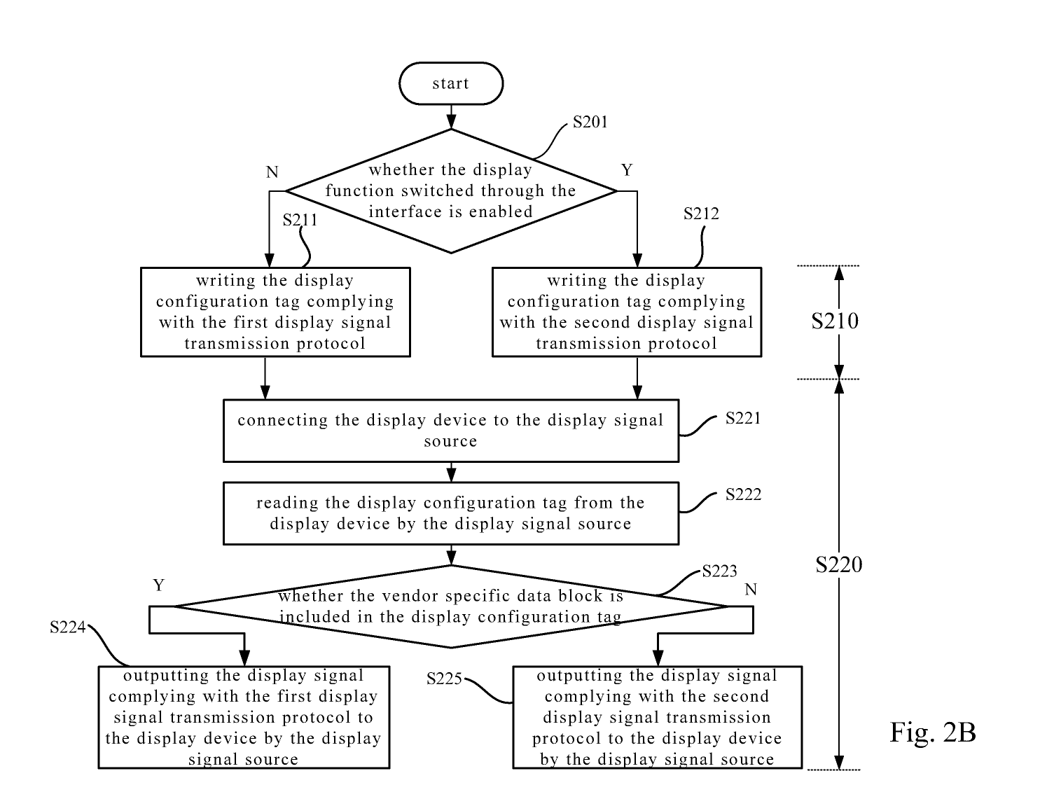

Referring to FIG. 2A, it illustrates a schematic flow diagram of a display-controlling method according to a first embodiment of this invention. The display-controlling method is used for controlling the display device to dynamically adjust the display configuration tag. In this embodiment, the display signal source connected with the display device may selectively provide the display signal complying with the first display signal transmission protocol or the second display signal transmission protocol according to the display configuration tag. As shown in FIG. 2A, a step S200 is firstly performed by the display-controlling method to determine whether a predetermined display function is enabled on the display device, and in a first embodiment, the predetermined display function is the edge blending function.

Then, a step S210 will be performed by the display-controlling method, wherein the display configuration tag complying with the first display signal transmission protocol or the display configuration tag complying with the second display signal transmission protocol is selectively written into a storage unit of the display device according to whether the edge blending function of the display device is enabled. In this embodiment, the first display signal transmission protocol may be the HDMI protocol, while the second display signal transmission protocol may be the DVI protocol.

The step S210 is further divided into steps S211 and S212. As shown in FIG. 2A, when the predetermined display function (e.g., the edge blending function in this embodiment) is not enabled, the step S211 is performed by the display-controlling method, wherein the display configuration tag complying with the first display signal transmission protocol is written into the storage unit of the display device.

The display configuration tag complying with the first display signal transmission protocol includes a vendor specific data block (VSDB).

On the basic of original display configuration tag (e.g., EDID), the HDMI protocol further establishes additional regulations related to an extension block of EDID. The extended portion (i.e., the extension block of EDID) includes a time parameter, terminal state information, display support clock, support format and VSDB, wherein, the VSDB is exclusive to an extended version EDID under the HDMI protocol.

On the other hand, when the predetermined display function (the edge blending function in this embodiment) is enabled, the step S212 is performed by the display-controlling method, wherein the display configuration tag (such as the EDID) complying with the second display signal transmission protocol (such as the DVI) is written into the storage unit of the display device, and the VSDB is not included in the display configuration tag complying with the second display signal transmission protocol (such as the DVI).

The process of selectively writing the display configuration tag complying with different display signal transmission protocols has been completed according to the step S200 to the step S212 in the above-mentioned display-controlling method.

Then, in a part of the embodiments, the display-controlling method may further include a step S220, wherein, the display signal source reads the display configuration tag and selectively provides the display signal complying with the first display signal transmission protocol or the second display signal transmission protocol to the display device. The step S220 may further be divided into steps S221, S222, S223, S224 and S225.

Firstly, the step S221 is performed by the display-controlling method, wherein the display device is connected to the display signal source (for example, a personal computer, a display system server or a video display card). Then, the step S222 is performed, wherein the display signal source reads the display configuration tag from the storage unit of the display device.

Finally, the step S223 is performed to determine whether the display configuration tag includes the VSDB.

Generally, in order to confirm whether the receiving end (the display device) is an HDMI device, the display signal source has to check whether a VSDB description exists in the EDID of the receiving end (the display device). The receiving end (the display device) may respond automatically, as long as a related response is received by the display signal source, and the receiving end (the display device) is considered as the HDMI device. Otherwise the device connected to the receiving end is considered as the DVI device. This VSDB description may be used for effectively recognizing a pattern of the display device by the display signal source, so as to transfer the display signal with a correct format to the receiving end (the display device) for displaying.

When the VSDB is included in the display configuration tag, a step S224 is performed, wherein the display signal source outputs the display signal complying with the first display signal transmission protocol (such as the HDMI) to the display device.

When the VSDB is not included in the display configuration tag, a step S225 is performed, wherein the display signal source outputs the display signal complying with the second display signal transmission protocol (such as the DVI) to the display device.

It can be seen from the first embodiment shown in FIG. 2A that, when the predetermined display function (that is, the edge blending function) is enabled on the display device, the display configuration tag complying with the second display signal transmission protocol (DVI) is written into the storage unit of the display device, so as to dynamically configure the display configuration tag of the display device to comply with the second display signal transmission protocol (DVI). Therefore, the predetermined display function (that is, the edge blending function) may be enabled normally by the display signal source. Therefore, it may be avoided that the display device (the projector) is determined as the HDMI device and the associated horizontal/vertical spanning function is closed by the display signal source.

That is, the display-controlling method in the first embodiment may be used for dynamically adjusting the display configuration tag of the display device according to whether the predetermined display function (that is, the edge blending function) is enabled on the display device.

However, the predetermined display function in the display-controlling method of this invention is not only limited to the edge blending function disclosed in the first embodiment. Referring to FIG. 2B, it illustrates a schematic flow diagram of a display-controlling method according to a second embodiment of this invention.

In the second embodiment, the predetermined display function also may be any display function of the display device that is switchable by the user through the on-screen display (OSD) interface or communication connection interface of the display device, for example, various display functions of the display device, such as a display setting (such as a scanning frequency and resolution) or operational mode (such as single frame operation, multiple frames combination and frame zoom in/zoom out), which are adjusted by the user through the OSD interface/communication connection interface. As shown in FIG. 2B, a step S201 is performed by the display-controlling method to determine whether other display functions specified by the user through the OSD interface or communication connection interface are enabled. Then, the content of the display configuration tag is dynamically changed by the steps S210 and S220 according to whether the above display functions are enabled, such that the display configuration tag is complying with different display signal transmission protocols. The control detail in the second embodiment is roughly the same with that in the first embodiment, which is not illustrated any further herein. In the second embodiment, the user may dynamically adjust the display configuration tag on the display device actively through the OSD interface or the communication connection interface (such as a RS-232 interface).

That is, the content of the display configuration tag may be dynamically adjusted by the display-controlling method of this invention according to whether various predetermined display functions are enabled on the display device, which is not only limited to the edge blending function.

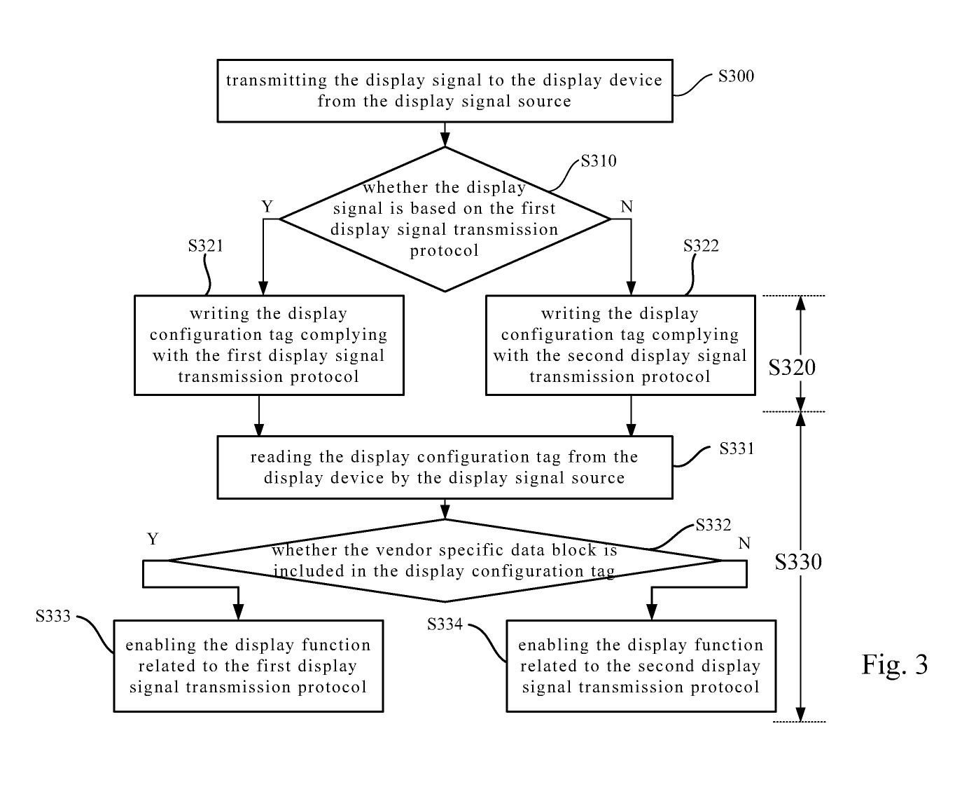

Then, referring to FIG. 3 together, it illustrates a schematic flow diagram of a display-controlling method according to a third embodiment of this invention. In the third embodiment shown in FIG. 3, the display configuration tag in the display device may be dynamically adjusted by the display-controlling method according to the characteristic of the display signal transmitted to the display device from the display signal source. The display configuration tag may be the EDID.

In this embodiment, the display device (such as the projector) is connected with the display signal source (such as the personal computer, display system server or video display card). As shown in FIG. 3, a step S300 is firstly performed by the display-controlling method, wherein the display signal is transmitted from the display signal source to the display device.

Then, a step S310 is performed, wherein the display device determines whether the display signal is complying with the first display signal transmission protocol. In this embodiment, the first display signal transmission protocol may be the HDMI protocol.

In the step S310, whether the display signal is complying with the first display signal transmission protocol may be known by determining whether the display signal includes an audio portion in the display-controlling method. If the display signal includes the audio portion, then the display signal is determined to be complying with the first display signal transmission protocol, that is, the HDMI protocol.

Then, a step S320 is performed, wherein the display configuration tag complying with the first display signal transmission protocol or the display configuration tag complying with the second display signal transmission protocol is written into the storage unit of the display device according to whether the display signal is complying with the first display signal transmission protocol. In this embodiment, the second display signal transmission protocol may be the DVI protocol.

The step S320 is further divided into steps S321 and S322. As shown in FIG. 3, when the display signal is complying with the first display signal transmission protocol, the step S321 is performed by the display-controlling method, wherein the display configuration tag (EDID) complying with the first display signal transmission protocol (HDMI) is written into the storage unit of the display device. The display configuration tag complying with the first display signal transmission protocol includes the VSDB.

On the other hand, when the display signal is not complying with the first display signal transmission protocol, the step S322 is performed by the display-controlling method, wherein the display configuration tag (EDID) complying with the second display signal transmission protocol (DVI) is written into the storage unit of the display device. The VSDB is not included in the display configuration tag complying with the second display signal transmission protocol.

Then, a step S330 is performed, wherein the display signal source reads the display configuration tag from the display device and selectively enables a display function related to the first display signal transmission protocol or the second display signal transmission protocol.

The step S330 is further divided into steps S331, S332, S333 and S334.

Firstly, the step S331 is performed by the display-controlling method, wherein the display signal source reads the display configuration tag from the display device.

Then, the step S332 is performed, wherein the display signal source determines whether the VSDB is included in the display configuration tag.

If the VSDB is included in the display configuration tag, then the step S333 is performed, wherein the display function related to the first display signal transmission protocol is enabled by the display signal source.

On the other hand, if the VSDB is not included in the display configuration tag, then a step S334 is performed, wherein the display function related to the second display signal transmission protocol is enabled by the display signal source.

Therefore, the display-controlling method in this embodiment may be used for dynamically adjusting the display configuration tag in the display device according to the characteristic of the display signal transmitted to the display device from the display signal source, to enhance the compatibility between the display signal source and the display device.

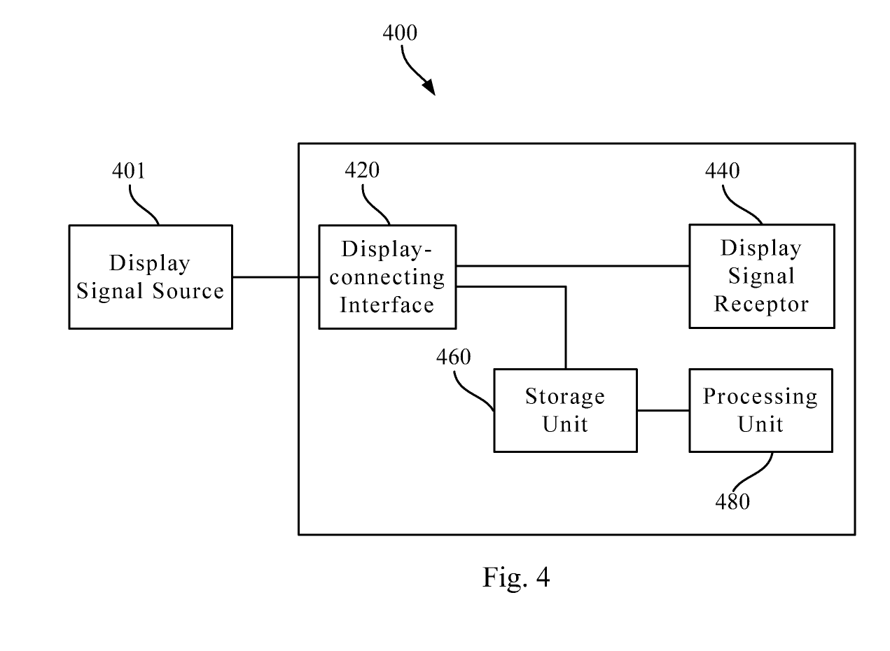

Referring to FIG. 4, it illustrates a schematic diagram of a display device 400 according to an embodiment of this invention. The display device 400 includes a display-connecting interface 420, a display signal receptor 440, a storage unit 460 and a processing unit 480. The display-connecting interface 400 is connected to a display signal source 401. The display signal receptor 440 is coupled with the display-connecting interface 420 for receiving the display signal from the display signal source 401. The storage unit 460 is coupled with the display-connecting interface 420 for storing the display configuration tag. In this embodiment, the storage unit 460 is a non-volatile memory unit.

The processing unit 480 is coupled with the storage unit 460 for selectively writing the display configuration tag complying with the first video signal transmission protocol or the second display signal transmission protocol into the storage unit 460.

In an embodiment, the processing unit 480 is operable to selectively write the display configuration tag complying with the first display signal transmission protocol or the second display signal transmission protocol according to whether the predetermined display function of the display device 400 is enabled. The predetermined display function may be the edge blending function (referring to the above-mentioned first embodiment together). On the other hand, the predetermined display function can be other display functions, which are switchable through the OSD interface or the communication connection interface of the display device (referring to the above-mentioned second embodiment together).

In another embodiment, the processing unit 480 may be further coupled with the display signal receptor 440 (not shown), and the processing unit 480 is operable to selectively write the display configuration tag complying with the first display signal transmission protocol or the second display signal transmission protocol according to whether the display signal is complying with the first display signal transmission protocol (referring to the above-mentioned third embodiment together). In this embodiment, the processing unit is operable to determine whether the display signal is complying with the first display signal transmission protocol according to whether the audio portion is included in the display signal.

In the above-mentioned embodiment, the display configuration tag complying with the first display signal transmission protocol includes the VSDB. The first display signal transmission protocol may be the HDMI protocol, and the second display signal transmission protocol may be the DVI protocol.

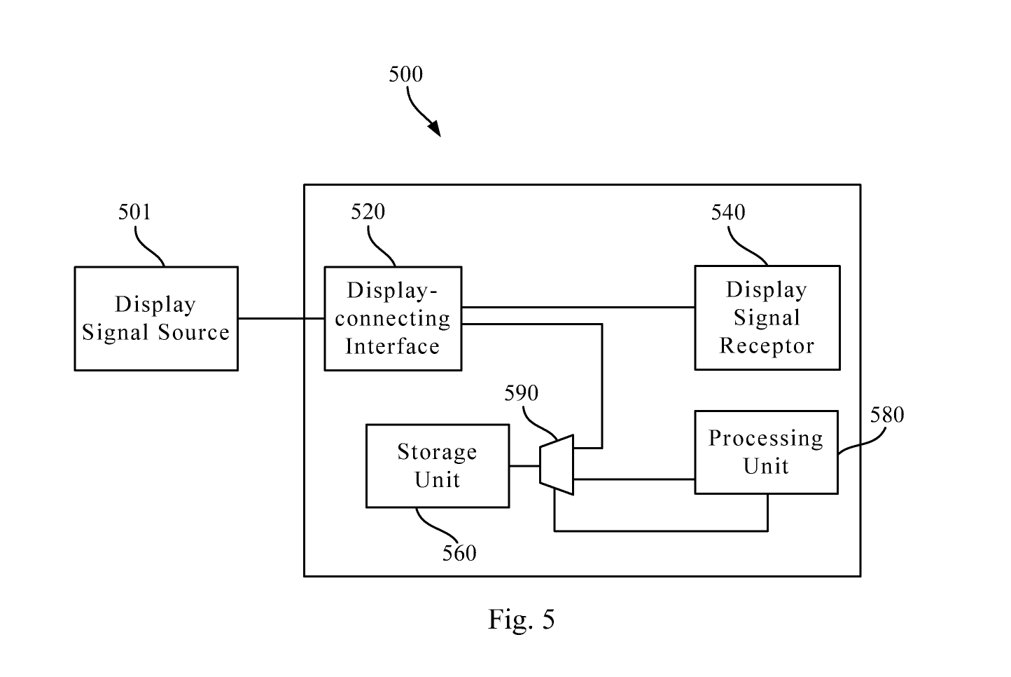

Referring to FIG. 5, it illustrates a schematic diagram of a display device 500 according to another embodiment of this invention. Compared to the display device 400 in the embodiment shown in FIG. 4, the display device 500 in this embodiment further includes a multiplexer 590 coupled among a display-connecting interface 520, a processing unit 580 and a storage unit 560. The storage unit 560 is selectively connected with the display-connecting interface 520 or the processing unit 580 through the multiplexer 590. For example, when a new display configuration tag will be written into the storage unit 560 by the processing unit 580, the multiplexer 590 is switched to connect the storage unit 560 with the processing unit 580. In the rest time, the multiplexer 590 is switched to connect the storage unit 560 with the display-connecting interface 520, and it is beneficial for a display signal source 501 to read the display configuration tag in the storage unit 560.

In view of the above, this invention provides a display-controlling method for controlling the display device to dynamically adjust the display configuration tag of the display device itself. For example, the content of the display configuration tag may be dynamically changed according to whether some predetermined display functions (for example, the edge blending function or other display-operating functions specified by the user through the OSD interface or the communication connection interface) are enabled, such that the display configuration tag is complying with different display signal transmission protocols, so as to make the predetermined display functions performed correctly and smoothly. Alternatively, the display device may be operable to dynamically change the content of the display configuration tag on the display device according to the signal characteristic of the display signal transmitted from the display signal source, such that a more preferred compatibility exists between the display device and the display signal source.

Although this invention has been disclosed with reference to the above embodiments, these embodiments are not intended to limit this invention. It will be apparent to those of skills in the art that various variations and modifications can be made without departing from the spirit and scope of this invention. Therefore, the scope of this invention should be defined by the appended claims.

What is claimed is:

1. A display-controlling method for controlling a display device to dynamically adjust a display configuration tag, a display signal source connected with the display device being used for selectively providing a display signal complying with a first display signal transmission protocol or a second display signal transmission protocol according to the display configuration tag, the display-controlling method comprising:
determining whether a predetermined display function is enabled on the display device; and
selectively writing the display configuration tag complying with the first display signal transmission protocol or the display configuration tag complying with the second display signal transmission protocol into a storage unit of the display device according to whether the predetermined display function of the display device is enabled.

2. The display-controlling method of claim 1, wherein, when the predetermined display function is not enabled, the display configuration tag complying with the first display signal transmission protocol is written into the storage unit according to the display-controlling method, and a vendor specific data block (VSDB) is comprised by the display configuration tag complying with the first display signal transmission protocol.

3. The display-controlling method of claim 2, wherein, when the predetermined display function is enabled, the display configuration tag complying with the second display signal transmission protocol is written into the storage unit according to the display-controlling method, and the vendor specific data block is not comprised by the display configuration tag complying with the second display signal transmission protocol.

4. The display-controlling method of claim 1, further comprising:
reading the display configuration tag from the storage unit of the display device by the display signal source; and
selectively enabling the predetermined display function and selectively providing the display signal complying with the first display signal transmission protocol or the second display signal transmission protocol to the display device by the display signal source according to whether a vendor specific data block is comprised by the display configuration tag.

5. The display-controlling method of claim 1, wherein the predetermined display function is an edge blending function.

6. The display-controlling method of claim 1, wherein the predetermined display function is a display function switchable through an on-screen display interface or a communication connection interface of the display device.

7. A display-controlling method for controlling a display device to dynamically adjust a display configuration tag, wherein the display device is connected to a display signal source, and the display-controlling method comprises:
transmitting a display signal to the display device from the display signal source;
determining whether the display signal is complying with a first display signal transmission protocol by the display device; and
selectively writing the display configuration tag complying with the first display signal transmission protocol or the display configuration tag complying with the second display signal transmission protocol into a storage unit of the display device according to whether the display signal is complying with the first display signal transmission protocol.

8. The display-controlling method of claim 7, wherein the step of determining whether the display signal is complying with the first display signal transmission protocol by the display device further comprises:
determining whether an audio portion is comprised in the display signal; and
determining whether the display signal is complying with the first display signal transmission protocol if the audio portion is comprised in the display signal.

9. The display-controlling method of claim 7, wherein when the display signal is complying with the first display signal transmission protocol, the display configuration tag complying with the first display signal transmission protocol is written into the storage unit according to the display-controlling method, and a vendor specific data block (VSDB) is comprised in the display configuration tag complying with the first display signal transmission protocol.

10. The display-controlling method of claim 7, wherein when the display signal is not complying with the first display signal transmission protocol, the display configuration tag complying with the second display signal transmission protocol is written into the storage unit according to the display-controlling method, and the vendor specific data block is not comprised in the display configuration tag complying with the second display signal transmission protocol.

11. The display-controlling method of claim 7, further comprising:
reading the display configuration tag from the display device by the display signal source; and
selectively enabling the display function related to the first display signal transmission protocol or the second display signal transmission protocol by the display signal source according to whether a vendor specific data block is comprised in the display configuration tag.

12. A display device, comprising:
a display-connecting interface configured for being connected to a display signal source;
a display signal receptor coupled with the display-connecting interface for receiving a display signal from the display signal source;
a storage unit coupled with the display-connecting interface for storing a display configuration tag; and
a processing unit coupled with the storage unit for selectively writing the display configuration tag complying with the first display signal transmission protocol or the second display signal transmission protocol into the storage unit.

13. The display device of claim 12, wherein the display device further comprises a multiplexer coupled among the display-connecting interface, the processing unit and the storage unit, and the storage unit is selectively connected with the display-connecting interface or the processing unit by the multiplexer.

14. The display device of claim 12, wherein the display configuration tag complying with the first display signal transmission protocol or the second display signal transmission protocol is selectively written by the processing unit according to whether a predetermined display function of the display device is enabled.

15. The display device of claim 14, wherein the predetermined display function is an edge blending function.

16. The display device of claim 14, wherein the predetermined display function is a display function switchable through an on-screen display interface or a communication connection interface of the display device.

17. The display device of claim 12, wherein the processing unit is further coupled with the display signal receptor, and the display configuration tag complying with the first display signal transmission protocol or the second display signal transmission protocol is selectively written by the processing unit according to whether the display signal is complying with the first display signal transmission protocol.

18. The display device of claim 17, wherein the processing unit determines whether the display signal is complying with the first display signal transmission protocol according to whether an audio portion is comprised in the display signal.

19. The display device of claim 12, wherein the display configuration tag complying with the first display signal transmission protocol comprises a VSDB.

20. The display device of claim 12, wherein the storage unit is a non-volatile memory unit.
